(19) United States
(12) Patent Application Publication
(10) Pub. No.: US 2019/0159628 A1
(43) Pub. Date: May 30, 2019

(54) SMART TEMPERATURE-CONTROLLED COOKING SYSTEM AND COOKING METHOD

(71) Applicant: IYUAN CHEN, FREMONT, CA (US)

(72) Inventor: IYUAN CHEN, FREMONT, CA (US)

(21) Appl. No.: 16/104,264

(22) Filed: Aug. 17, 2018

(30) Foreign Application Priority Data
Nov. 24, 2017 (TW) 106141045

(51) Int. Cl. A47J 36/32; G06F 17/30; A23L 5/10

(52) U.S. Cl. CPC A47J 36/321; G06K 7/1417; A23L 5/15; G06F 17/30879

(57) ABSTRACT

The present invention provides a smart temperature-controlled cooking system for adjusting the temperature of the body to be heated. The smart temperature-controlled cooking system comprises an electronic tag, a mobile electronic device, and a cooking apparatus. The electronic tag includes the product information corresponding to the body to be heated. The mobile electronic device includes an image extraction device and a first wireless transmission module. The image extraction device can extract the electronic tag. The cooking apparatus includes a second wireless transmission module and a control unit. The second wireless transmission module is connected in signal with the first wireless transmission module. The control unit is connected electrically with the second wireless transmission module. The cooking apparatus receives a cooking procedure corresponding to the product information. Then the control unit reads the cooking procedure for cooking the body to be heated.

### FIELD OF THE INVENTION

The present invention relates generally to a cooking system, and particularly to a smart temperature-controlled cooking system and cooking method operated by a mobile electronic device.

### BACKGROUND OF THE INVENTION

Nowadays, there are many ways of cooking for people, including steaming, boiling, and roasting. Corresponding to different cooking methods, various catering cultures are generated. Thanks to the development of modern technologies, many cooking apparatuses are invented. Unfortunately, commercial cooking apparatuses mainly adopt mechanical or electronic interfaces for controlling the power switch and setting the power and time. It requires a user to operate the mechanical or electronic buttons or knobs manually for adjusting the cooking parameters of the commercial cooking apparatuses.

For different foods to be cooked, the user must readjust the cooking parameters of a commercial cooking apparatus. Since most users are not well experienced in cooking, false cooking occurs easily, resulting in waste of food bodies and time.

Accordingly, how to design a cooking apparatus that can adjust cooking parameters for different kinds of foods to be cooked without relying on users' experience and cooking food perfectly has become an urgent challenge in the field.

### SUMMARY

An objective of the present invention is to provide a smart temperature-controlled cooking system and cooking method, which adopt a mobile electronic device to read the product information of a body to be heated such that the cooking apparatus can cook the body to be heated according to the product information directly and thus achieving the effect of smart cooking.

To achieve the above objective, the present invention provides a smart temperature-controlled cooking system for adjusting the temperature of the body to be heated. The smart temperature-controlled cooking system comprises an electronic tag, a mobile electronic device, and a cooking apparatus. The electronic tag includes the product information corresponding to the body to be heated. The mobile electronic device includes an image extraction device and a first wireless transmission module. The image extraction device can extract the electronic tag. The cooking apparatus includes a second wireless transmission module and a control unit. The second wireless transmission module is connected in signal with the first wireless transmission module. The control unit is connected electrically with the second wireless transmission module. The cooking apparatus receives a cooking procedure corresponding to the product information. Then the control unit reads the cooking procedure for cooking the body to be heated.

To achieve the above objective, the present invention provides a smart temperature-controlled cooking method, which comprises the following steps:
Step (a): Provide a smart temperature-controlled cooking system and a body to be heated. The system comprises an electronic tag, a mobile electronic device, and a cooking apparatus. The electronic tag includes the product information corresponding to the body to be heated. The mobile electronic device includes an image extraction device and a first wireless transmission module. The image extraction device can extract the electronic tag. The cooking apparatus includes a second wireless transmission module and a control unit. The second wireless transmission module is connected in signal with the first wireless transmission module. The control unit is connected electrically with the second wireless transmission module.
Step (b): The image extraction device extracts the electronic tag.
Step (c): The mobile electronic device receives the product information, and produces a cooking procedure corresponding to the product information.
Step (d): The first wireless transmission module transmits the cooking procedure to the second wireless transmission module.
Step (e): The control unit reads the cooking procedure and cooks the body to be heated.

### BRIEF DESCRIPTION OF THE DRAWINGS

FIG. 1 shows a schematic diagram of the smart temperature-controlled cooking system according to a first preferred embodiment of the present invention;

FIG. 2 shows a flowchart of the smart temperature-controlled cooking method according to a first preferred embodiment of the present invention;

FIG. 3 shows a schematic diagram of the smart temperature-controlled cooking system according to a second preferred embodiment of the present invention; and

FIG. 4 shows a flowchart of the smart temperature-controlled cooking method according to a second preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

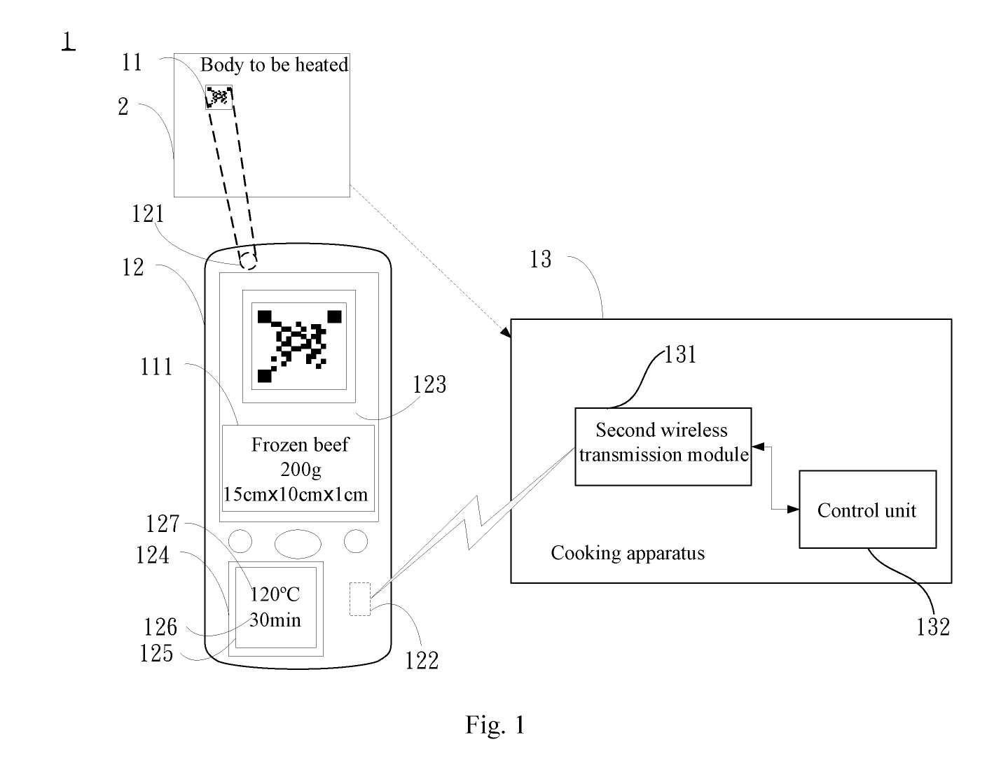

Please refer to FIG. 1, which shows a schematic diagram of the smart temperature-controlled cooking system according to a preferred embodiment of the present invention. The smart temperature-controlled cooking system 1 according to the present invention can adjust the temperature of a body to be heated 2. The smart temperature-controlled cooking system 1 comprises an electronic tag 11, a mobile electronic device 12, and a cooking apparatus 13. The body to be heated 2 is usually covered by a package body (not shown in the figure). The electronic tag 11 is adhered to the package body. The electronic tag 11 is a two-dimensional barcode. Thereby, the electronic tag 11 can store the product information 111 corresponding to the body to be heated 2. The product information 111 includes the information of product type, material type, weight, or size of the body to be heated 2. The product type can be, for example, freezing type, refrigerating type, or room-temperature type. The material type can be, for example, beef, pork, mutton, mushroom, toast. The unit for weight is preferably gram. The unit for size is preferably centimeter, and the size is preferably labeled in length*width*height.

The mobile electronic device 12 is preferably a smartphone or a tablet computer. It includes an image extraction device 121 and a first wireless transmission module 122. The image extraction device 121 is a lens device for extracting the electronic tag 11. According to a preferred embodiment of the present invention, the mobile electronic device 12 includes a mobile application program (APP) 123, which can covert the extracted images of the electronic tag 11 into digital product information 111. The mobile electronic device 12 further includes a memory device 124 for storing one or more cooking procedure 125. The cooking procedure 125 corresponds to the product information 111. In addition, the cooking procedure 125 includes the quantities of one or more heating time 126 and one or more heating temperature 127.

The cooking apparatus 13 include a second wireless transmission module 131 and a control unit 132. The second wireless transmission module 131 is connected with the first wireless transmission module 122. The control unit 132 is connected electrically with the second wireless transmission module 131. The cooking apparatus 13 receives the cooking procedure 125 using the second wireless transmission module 131. Then the control unit 132 reads the cooking procedure 125 for cooking the body to be heated 2.

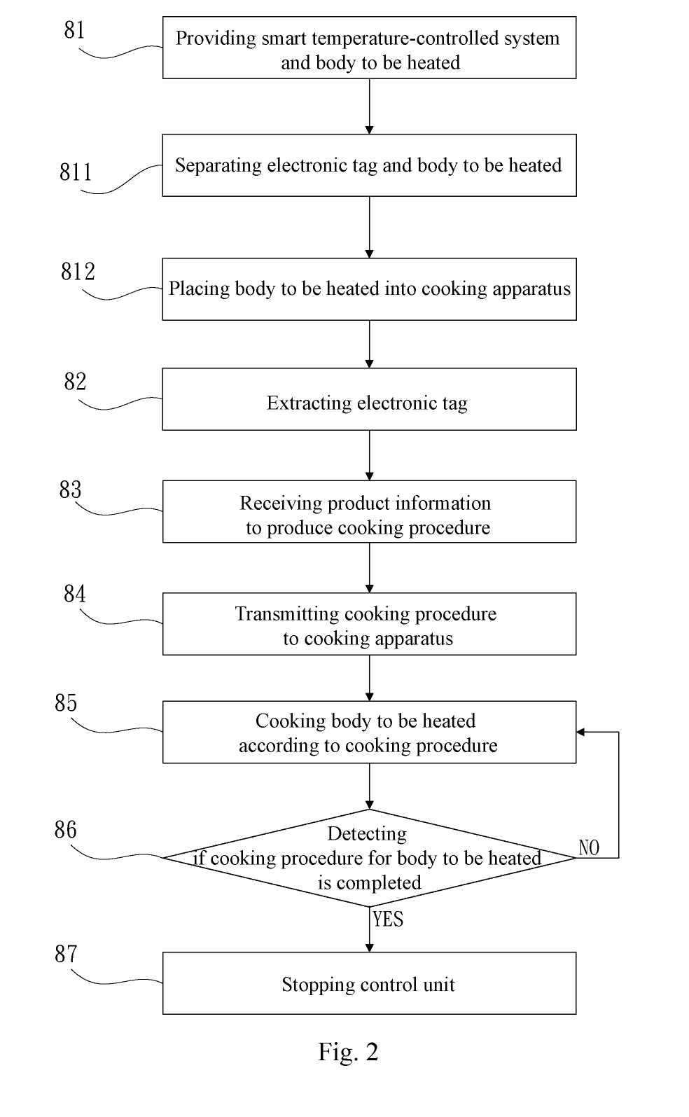

Please refer to FIG. 2, which shows a flowchart of the smart temperature-controlled cooking method according to a preferred embodiment of the present invention. The smart temperature-controlled cooking method according to the present invention comprises the following steps.

Step 81: Provide a smart temperature-controlled cooking system 1 (as the preferred embodiment shown in FIG. 1) and a body to be heated 2. The system comprises an electronic tag 11, a mobile electronic device 12, and a cooking apparatus 13. The electronic tag 11 includes the product information 111 corresponding to the body to be heated 2. The mobile electronic device 12 includes an image extraction device 121 and a first wireless transmission module 122. The cooking apparatus 13 include a second wireless transmission module 131 and a control unit 132. The second wireless transmission module 131 is connected in signal with the first wireless transmission module 122. The control unit 132 is connected electrically with the second wireless transmission module 131.

The body to be heated 2 is usually covered by a package body, and the electronic tag 11 is adhered to the package body. Thereby, while using the smart temperature-controlled cooking method according to the present invention, the body to be heated 2 is first drawn out from the package body. Then separate the electronic tag 11 from the body to be heated 2 (Step 811) before placing the body to be heated 2 into the cooking apparatus 13 (Step 812).

According to a preferred embodiment, the electronic tag 11 is a two-dimensional barcode and the image extraction device 121 is a lens device. Thereby, the image extraction device 121 can extract the image of the electronic tag 11 directly (Step 82).

The mobile electronic device 12 includes an APP 123 and a memory device 124. By using the APP 123, the image of the electronic tag 11 can be converted to digital product information 111. The memory device 124 stores one or more cooking procedure 125. As the mobile electronic device 12 receives the product information 111, a cooking procedure 125 corresponding to the product information 111 is produced (Step 83). In addition, the cooking procedure 125 includes the quantities of one or more heating time 126 and one or more heating temperature 127.

Because the cooking procedure 125 is digital information, the first wireless transmission module 122 can be used directly to transmit the cooking procedure 125 to the second wireless transmission module 131 (Step 84). Finally, the control unit 132 reads the cooking procedure 125 and cook the body to be heated 2 according to the cooking procedure 125 (Step 85). Afterwards, in the cooking process, the control unit 132 detects frequently if the cooking procedure 125 is completed for the body to be heated 2 (Step 86). When the cooking procedure 125 for the body to be heated 2 is not completed, the control unit 132 cooks the body to be heated 2 repeatedly (Step 85). When the cooking procedure 125 for the body to be heated 2 is completed, the control unit 132 stops (Step 87), and thus stopping cooking.

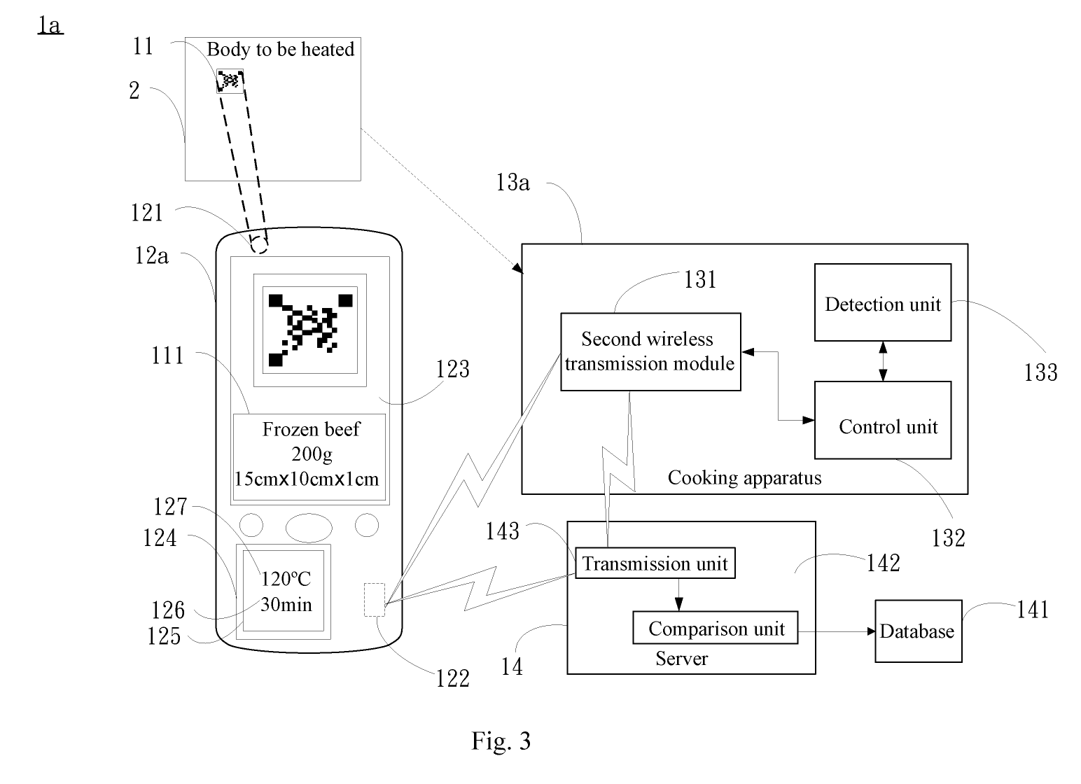

Please refer to FIG. 3, which shows a schematic diagram of the smart temperature-controlled cooking system according to another preferred embodiment of the present invention. The difference between the present embodiment and the previous one is that the mobile electronic device 12a in the smart temperature-controlled cooking system according to the present embodiment does not include the stored cooking procedure 125. Consequently, it is not possible for the mobile electronic device 12a to compare with the product information 111 for retrieving the corresponding cooking procedure 125. Instead, the mobile electronic device 12a is connected in signal to a server 14. Preferably, the server 14 is connected in signal to the cooking device 13a. The server 14 includes a database 141, a comparison unit 142, and a transmission unit 143. The database 141 and the comparison unit 142 are connected electrically and the comparison unit 142 and the transmission unit 143 are connected electrically. The database stores a plurality of cooking procedures 125 corresponding to the product information 111. The comparison unit 142 compares the corresponding cooking procedure 125 of the product information 111. The transmission unit 143 transmits the cooking procedure 125 to the mobile electronic device 12a, which then transmits the cooking procedure 125 to the cooking apparatus 13a. Alternatively, the transmission unit 143 can transmit the cooking procedure 125 to the cooking apparatus 13a directly. Moreover, the cooking apparatus 13a further includes a detection unit 133 connected electrically with the control unit 132. The detection unit 133 detects if the cooking apparatus 13a exceeds a safety temperature for guaranteeing the safety of the mobile electronic device 12a.

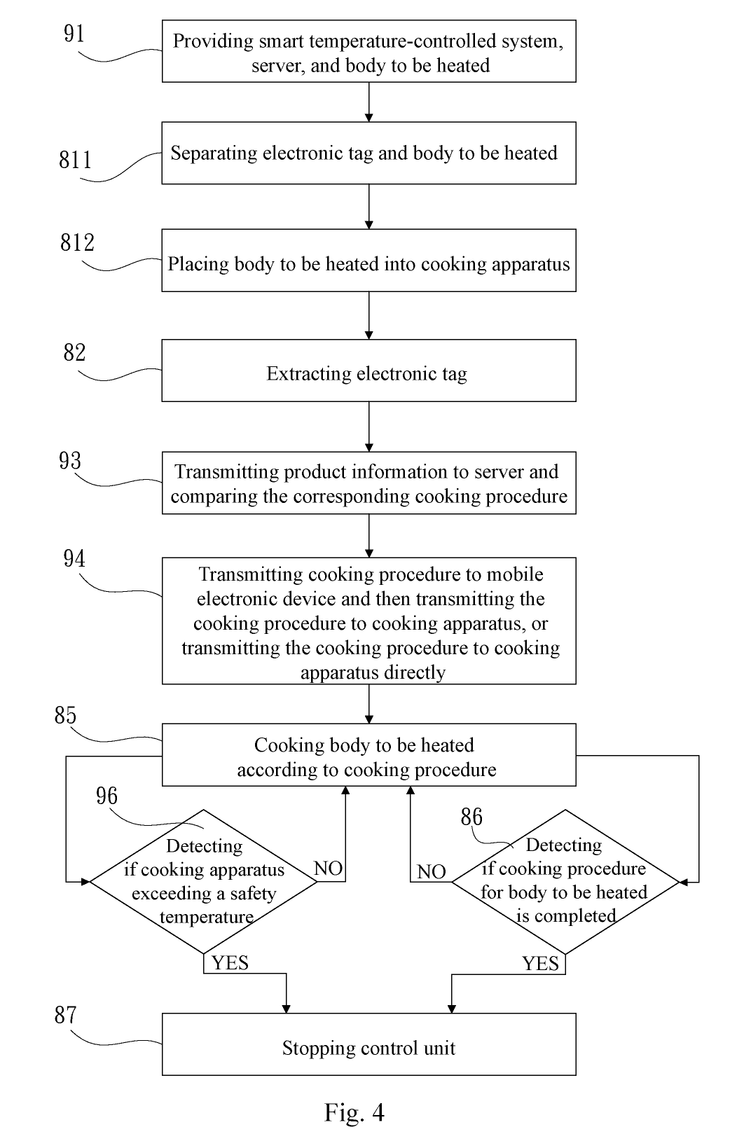

Please refer to FIG. 4, which shows a flowchart of the smart temperature-controlled cooking method according to another preferred embodiment of the present invention. According to the present preferred embodiment, in the Step 91, provide a smart temperature-controlled cooking system 1a (as the preferred embodiment shown in FIG. 3), a server 14, and a body to be heated 2. The mobile electronic device 12a is connected in signal with the server 14 and the server 14 is connected in signal with the cooking apparatus 13a.

Step 811 to Step 82 are mostly identical to the ones in the previous embodiment and will be described briefly here. Step 811: Separate the electronic tag 11 from the body to be heated 2. Step 812: Place the body to be heated 2 into the cooking apparatus 13. Step 82: The image extraction device 121 extracts the image of the electronic tag 11.

Besides, the mobile electronic device 12a transmits the product information 111 to the server 14. The server 14 uses the comparison unit 142 to compare the corresponding cooking procedure 125 of the product information in the database 141 (Step 93).

Step 94: The transmission unit 143 transmits the cooking procedure 125 to the mobile electronic device 12a, which next transmits the cooking procedure 125 to the cooking apparatus 13a. Alternatively, the transmission unit 143 transmits the cooking procedure 125 to the cooking apparatus 13a directly. Finally, like in the previous embodiment, the cooking apparatus 13a reads the cooking procedure 125 and the control unit 132 cooks the body to be heated according to the cooking procedure 125 (Step 85).

In the present embodiment, safety mechanism is added to the cooking apparatus 13a. The detection unit 133 is used for detecting if the cooking apparatus 13a exceeds a safety temperature (Step 96). If so, the control unit 132 stops and thus stopping cooking (Step 87). If not, the control unit 132 cooks the body to be heated 2 repeatedly (Step 85).

Like in the previous embodiment, in the cooking process, the control unit 132 detects frequently if the cooking procedure 125 is completed for the body to be heated 2 (Step 86). When the cooking procedure 125 for the body to be heated 2 is not completed, the control unit 132 cooks the body to be heated 2 repeatedly (Step 85). When the cooking procedure 125 for the body to be heated 2 is completed, the control unit 132 stops (Step 87), and thus stopping cooking.

To sum up, the present invention provides a smart temperature-controlled cooking method, which uses a mobile electronic device to read the product information of a body to be heated so that the cooking apparatus can cook the body to be heated directly according to the product information. Thereby, for different kinds of body to be heated, the cooking parameters can be adjusted smartly without relying on experience before quality food can be cooked.

Accordingly, the present invention conforms to the legal requirements owing to its novelty, non-obviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A smart temperature-controlled cooking system for heating a body to be heated, comprising:
an electronic tag, including product information corresponding to said body to be heated;
a mobile electronic device, including an image extraction device and a first wireless transmission module, and said image extraction device extracting said electronic tag; and
a cooking apparatus, including a second wireless transmission module and a control unit, said second wireless transmission module connected in signal with said first wireless transmission module, said control unit connected electrically with said second wireless transmission module, said cooking apparatus receiving a cooking procedure corresponding to said product information, and said control unit reading said cooking procedure for cooking said body to be heated.

2. The smart temperature-controlled cooking system of claim 1, wherein said electronic tag is a two-dimensional barcode.

3. The smart temperature-controlled cooking system of claim 1, wherein said product information includes the information of product type, material type, weight, or size of said body to be heated.

4. The smart temperature-controlled cooking system of claim 1, wherein said mobile electronic device includes a mobile application program.

5. The smart temperature-controlled cooking system of claim 1, wherein said cooking procedure include one or more heating time and one or more heating temperature.

6. The smart temperature-controlled cooking system of claim 1, and further comprising a server, having a database, a comparison unit, and a transmission unit, said database connected electrically with said comparison unit, said comparison unit connected electrically with said transmission unit, said database storing a plurality of cooking procedures corresponding to said product information, said comparison unit comparing the corresponding cooking procedure of said product information, and said transmission unit transmitting said cooking procedure to said mobile electronic device.

7. The smart temperature-controlled cooking system of claim 1, wherein said mobile electronic device further includes a memory device for storing one or more cooking procedure.

8. A smart temperature-controlled cooking method, comprising steps of:
providing a smart temperature-controlled cooking system and a body to be heated, said system comprising an electronic tag, a mobile electronic device, and a cooking apparatus, said electronic tag including the product information corresponding to said body to be heated, said mobile electronic device including an image extraction device and a first wireless transmission module, said cooking apparatus including a second wireless transmission module and a control unit, said second wireless transmission module connected in signal with said first wireless transmission module, and said control unit connected electrically with said second wireless transmission module;
extracting said electronic tag from said image extraction device;
receiving said product information from said mobile electronic device, and producing a cooking procedure corresponding to said product information;
transmitting said cooking procedure from said first wireless transmission module to said second wireless transmission module; and
reading said cooking procedure from said control unit and cooking said body to be heated.

9. The smart temperature-controlled cooking method of claim 8, and further comprising steps of:
separating said electronic tag and said body to be heated; and
placing said body to be heated into said cooking apparatus.

10. The smart temperature-controlled cooking method of claim 8, and further comprising steps of:
providing a server, connected in signal with said mobile electronic device, having a database, a comparison unit, and a transmission unit, said database connected electrically with said comparison unit, said comparison unit connected electrically with said transmission unit, said database storing a plurality of cooking procedures corresponding to said product information;
comparing the corresponding cooking procedure of said product information from said comparison unit; and
transmitting said cooking procedure to said mobile electronic device from said transmission unit.

11. The smart temperature-controlled cooking method of claim 8, and further comprising steps of said control unit detecting if said cooking procedure is completed for said body to be heated; when said cooking procedure for said body to be heated is not completed, said control unit cooking said body to be heated repeatedly; and when said cooking procedure for said body to be heated is completed, said control unit stopping.

12. The smart temperature-controlled cooking method of claim 8, and further comprising steps of:
providing a detection unit, connected electrically with said control unit; and
detecting if said cooking apparatus exceeding a safety temperature from said detection unit; when said cooking apparatus exceeding said safety temperature, said control unit stopping cooking said body to be heated; and when said cooking apparatus not exceeding said safety temperature, said control unit cooking said body to be heated repeatedly.
